(19) United States
(12) Patent Application Publication
(10) Pub. No.: US 2018/0352421 A1
(43) Pub. Date: Dec. 6, 2018

(54) Mobile Device Configuration Method And Apparatus

(71) Applicant: MediaTek Inc., Hsinchu City (TW)

(72) Inventors: Hsiao-Wen Chen, Taichung City (TW); Tsung-I Lin, New Taipei City (TW); Rahul Gupta, Noida (IN)

(21) Appl. No.: 15/992,133

(22) Filed: May 29, 2018

Related U.S. Application Data
(60) Provisional application No. 62/514,030, filed on Jun. 2, 2017.

(51) Int. Cl. H04W 8/18; G06F 8/656; H04W 8/20; H04W 4/50

(52) U.S. Cl. CPC H04W 8/183; G06F 8/656; H04W 4/60; H04W 4/50; H04W 8/205

(57) ABSTRACT

Various solutions for configuring a mobile device are described. A processor of the mobile device detects an occurrence of an event. In response to the occurrence of the event, the processor applies one or more aspects of one of a plurality of configuration files stored in the mobile device to a configuration of the mobile device. The event may include one of the following: (1) detecting an insertion of a subscriber identity module (SIM) card into the mobile device, (2) receiving a notification from an operator indicating availability of an upgrade for the one of the plurality of configuration files, and (3) receiving a user command to change the configuration of the mobile device.

### CROSS REFERENCE TO RELATED PATENT APPLICATION

The present disclosure is part of a non-provisional application claiming the priority benefit of U.S. Provisional Patent Application No. 62/514,030, filed on 2 Jun. 2017, the content of which is incorporated by reference in its entirety.

### TECHNICAL FIELD

The present disclosure is generally related to mobile devices and, more particularly, to configuration of mobile devices.

### BACKGROUND

Unless otherwise indicated herein, approaches described in this section are not prior art to the claims listed below and are not admitted as prior art by inclusion in this section.

With the prevalence of mobile devices (e.g., mobile phones and smartphones), at present time there are open-market devices and operator-branded devices on the market. Open-market devices are those mobile devices that, at the time of purchase by consumers, come with no specific customization or configuration. Operator-branded devices are those mobile devices that, at the time of purchase by consumers, come with customization for a given operator/service provider/carrier (hereinafter interchangeably referred as “operator”, “service provider” and “carrier”).

The Groupe Special Mobile Association (GSMA) is currently coordinating device configuration to reach standardized agreements. Meanwhile, more and more operators/service providers/carriers and device vendors start to define device configuration themselves. In one approach, configuration change on a mobile device for a single country or a single region is supported with the change of the subscriber identity module (SIM) card used with the mobile device. However, such approach only supports configuration change for a single country or region. Moreover, it is required to pre-configure the mobile device through a tool or software application before product launch/release (e.g., while the mobile device is still in the factory).

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

Under a proposed scheme in accordance with the present disclosure, a single software load or software build with configuration files and/or data for multiple countries, multiple regions, multiple operators and/or multiple customizations may be installed in a mobile device. Advantageously, the proposed scheme provides flexibility in compile time, boot time and runtime. Specifically, under the proposed scheme, configuration change may be achieved not only through a change of a SIM card but also through setting menu (e.g., initiated by a user of the mobile device) and/or over the air (e.g., initiated by an operator). Additionally, under the proposed scheme, application installation may be triggered may be triggered by insertion of the SIM card into the mobile device. For instance, one or more software applications may be installed (and one or more other software applications may be uninstalled) according to SIM card-specific information of the inserted SIM card. Moreover, besides modem settings and country/region settings, application customization and UI customization may also be supported under the proposed scheme.

In one aspect, a method may involve a processor of a mobile device detecting an occurrence of an event. Moreover, in response to the occurrence of the event, the method may involve the processor applying one or more aspects of one of a plurality of configuration files stored in the mobile device to a configuration of the mobile device.

In another aspect, an apparatus implementable in a mobile device may include a memory and a processor. The memory may be capable of storing a plurality of configuration files. The processor may be capable of accessing the plurality of configuration files stored in the memory. The processor may be also capable of detecting an occurrence of an event. In response to the occurrence of the event, the processor may be capable of applying one or more aspects of one of the plurality of configuration files to one or more settings of a configuration of the mobile device. The event may include one of the following: (1) detecting an insertion of a subscriber identity module (SIM) card into the mobile device, (2) receiving a notification from an operator indicating availability of an upgrade for the one of the plurality of configuration files, and (3) receiving a user command to change the configuration of the mobile device.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in which the proposed scheme in accordance with the present disclosure may be implemented.

FIG. 2 is a flowchart of an example process in accordance with an implementation of the present disclosure.

FIG. 3 is a flowchart of an example process in accordance with an implementation of the present disclosure.

FIG. 4 is a diagram of an example software architecture in accordance with an implementation of the present disclosure.

FIG. 5 is a diagram of an example system in accordance with an implementation of the present disclosure.

FIG. 6 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to mobile device configuration. According to the present disclosure, a number of possible solutions may be implemented separately or jointly. That is, although these possible solutions may be described below separately, two or more of these possible solutions may be implemented in one combination or another.

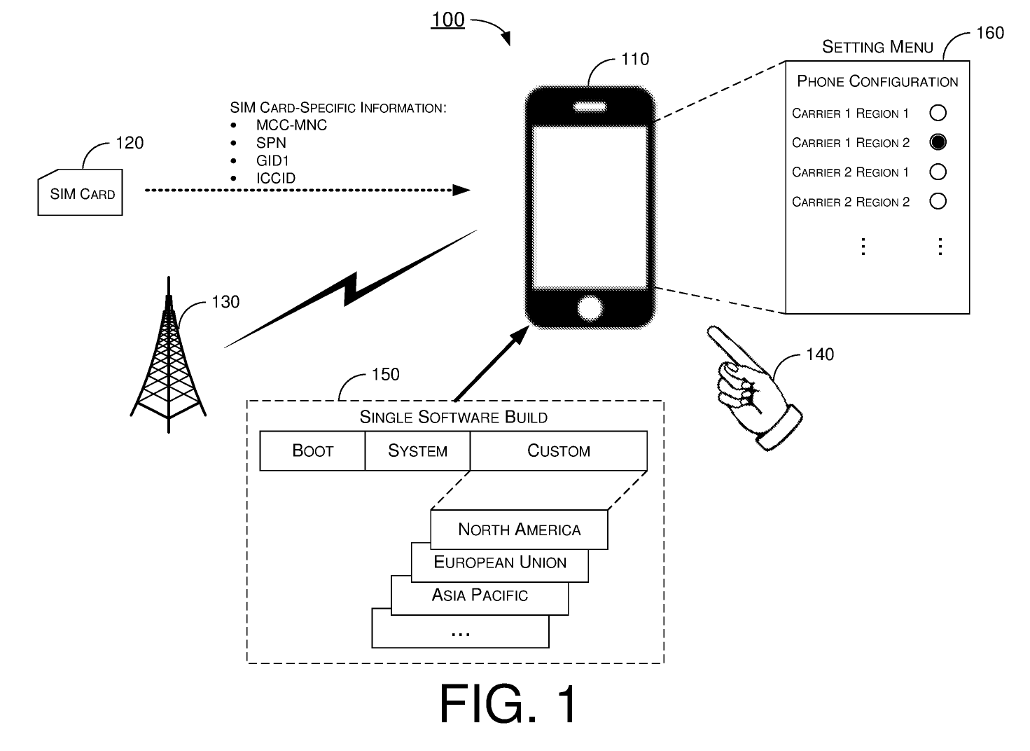

FIG. 1 illustrates an example scenario 100 in which the proposed scheme in accordance with the present disclosure may be implemented. Scenario 100 may involve a mobile device 110 the configuration of which may be changed in accordance various implementations of the present disclosure. Mobile device 110 may have installed therein a single software build 150. The single software build 150 may contain software codes and/or instructions as well as data for various aspects of mobile device 110 such as, for example and without limitation, boot-up of mobile device, operating systems, device configurations and settings, and configuration files for multiple countries, multiple regions, multiple operators and/or multiple customizations for higher-layer applications and user interface (UI) of mobile device 110.

Under the proposed scheme in accordance with the present disclosure, mobile device 110 may detect an occurrence of an event and, in response to detecting the occurrence of the event, mobile device 110 may apply one or more aspects of the single software build 150 to one or more settings of a configuration of mobile device 110. In some implementations, the event may include one of the following: (1) detecting an insertion of a SIM card 120 into mobile device 110, (2) receiving during runtime, via an operator network 130, a notification from a service provider indicating availability of an upgrade for one or more of a plurality of configuration files in the single software build 150, and (3) receiving a user command from a user 140 to change one or more settings of the configuration of mobile device 110.

Under the proposed scheme, in response to detecting the insertion of SIM card 120, mobile device 110 may retrieve or otherwise obtain SIM card-specific information from SIM card 120. For instance, the SIM card-specific information obtained by mobile device 110 may include some or all of the following: a mobile country code (MCC), a mobile network code (MNC), a service provider name (SPN), a level 1 group identifier (GID1), and an integrated-circuit card identifier (ICCID) of SIM card 120.

Under the proposed scheme, in applying the one or more aspects of the single software build 150, mobile device 110 may select a first configuration file of the plurality of configuration files in the single software build 150 based on the SIM card-specific information. For instance, mobile device 110 may apply one or more parameters of the first configuration file to one or more settings of the configuration of mobile device 110.

Under the proposed scheme, in response to detecting the insertion of SIM card 120, mobile device 110 may also determine whether SIM card 120 is valid based on the SIM card-specific information. Additionally, mobile device 110 may perform either of the following: (a) applying one or more parameters of a first configuration file of the plurality of configuration files in the single software build 150 to one or more settings of the configuration of mobile device 110 in an event that SIM card 120 is valid, and (b) applying one or more parameters of a second configuration file of the plurality of configuration files in the single software build 150 to the one or more settings of the configuration of mobile device 110 in an event that SIM card 120 is invalid.

Under the proposed scheme, in an event that mobile device 110 receives the notification from the service provider indicating the availability of the upgrade for the one of the plurality of configuration files in the single software build 150, in applying the one or more aspects of the one of the plurality of configuration files, mobile device 110 may perform a number of operations. For instance, processor 530 may download the upgrade from a server of the service provider via operator network 130. Additionally, mobile device 110 may update the one of the plurality of configuration files in the single software build 150 with the upgrade. Moreover, mobile device 110 may apply one or more parameters of the one of the plurality of configuration files in the single software build 150 to one or more settings of the configuration of mobile device 110.

Under the proposed scheme, in applying the one or more aspects of the one of the plurality of configuration files in the single software build 150, mobile device 110 may perform either of the following: (a) installing one or more software applications on mobile device 110 according to the one of the plurality of configuration files in the single software build 150, and (b) updating a UI on mobile device 110 or one or more software applications installed on mobile device 110 according to the one of the plurality of configuration files in the single software build 150.

Under the proposed scheme, in applying the one or more aspects of the one of the plurality of configuration files in the single software build 150, mobile device 110 may enable a first feature of mobile device 110 (e.g., a first software application installed on mobile device 110). Alternatively, or additionally, mobile device 110 may disable a second feature of mobile device 110 (e.g., a second software application installed on mobile device 110).

Under the proposed scheme, in applying the one or more aspects of the one of the plurality of configuration files in the single software build 150, mobile device 110 may request for user permission from user 140. Moreover, mobile device 110 may apply the one or more aspects of the one of the plurality of configuration files in the single software build 150 to one or more settings of the configuration of mobile device 110 in response to receiving a positive user response as the user permission. For instance, mobile device 110 may display a setting menu 160. The setting menu 160 may, based on the SIM card-specific information obtained from SIM card 120, include a list of available options for user 140 to select. In the example shown in FIG. 1, options in the setting menu 160 include Carrier 1 in Region 1, Carrier 1 in Region 2, Carrier 2 in Region 1, and Carrier 2 in Region 2. That is, user 140 may select one of the options to apply parameters of the configuration file for the selected carrier and region (e.g., North America, European Union or Asia Pacific) to corresponding settings of mobile device 110.

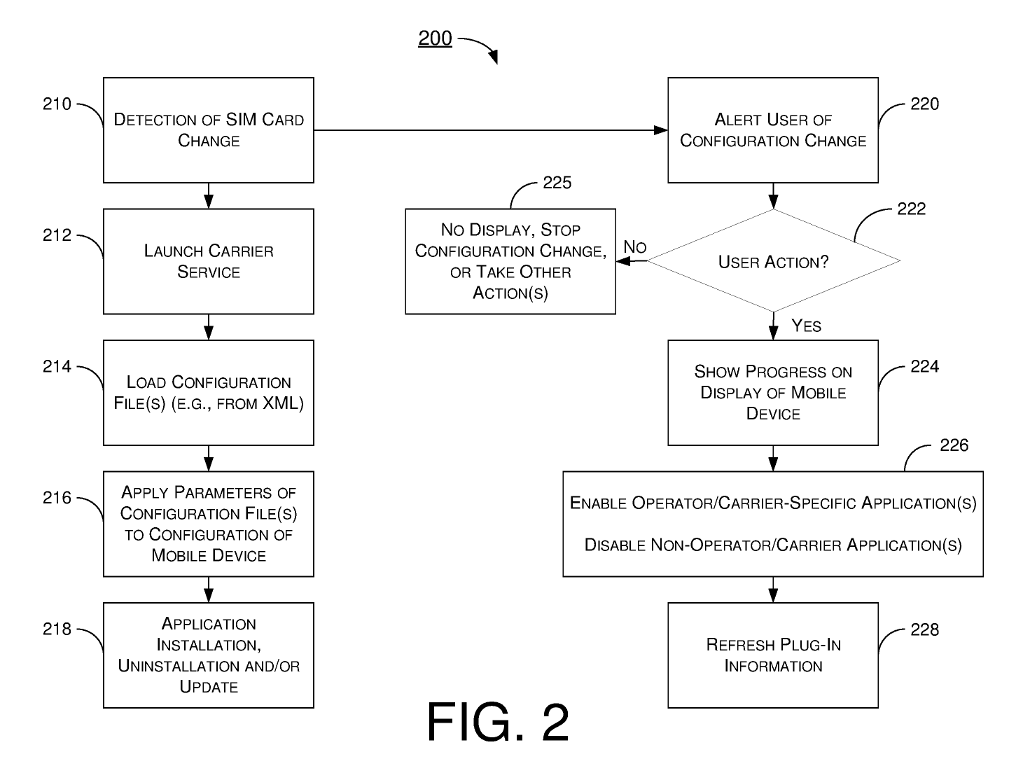

FIG. 2 illustrates an example process 200 of mobile device configuration in accordance with an implementation of the present disclosure. Process 200 may include one or more operations, actions, or functions as represented by one or more of blocks 210, 212, 214, 216, 218, 220, 222, 224, 225, 226 and 228. Although illustrated as discrete blocks, various blocks of process 200 may be divided into additional blocks, combined into fewer blocks, or eliminated, depending on the desired implementation. Process 200 may be implemented in scenario 100 by mobile device 110. For illustrative purposes and without limitation, process 200 is described below in the context of mobile device 110 in scenario 100. Process 200 may begin at 210.

At 210, process 200 may involve mobile device 110 detecting a SIM card change. For instance, mobile device 110 may detect that a previous SIM card has bee removed and that a new SIM card (e.g., SIM card 120) has been inserted into mobile device 110. Process 200 may proceed from 210 to 212 and/or 220.

At 212, process 200 may involve mobile device 110 launching a carrier service to effect configuration change thereof. Process 200 may proceed from 212 to 214.

At 214, process 200 may involve mobile device 110 loading one or more configuration files corresponding to SIM card 120. For instance, mobile device 110 may retrieve or otherwise obtain SIM card-specific information such as MCC-MNC of SIM card 120, and then select and load a configuration file corresponding to the MCC-MNC of SIM card 120. The configuration files in the single software build 150 may be written and stored as Extensible Markup Language (XML) files. Accordingly, mobile device 110 may load the XML file of the selected configuration file to effect configuration change. Process 200 may proceed from 214 to 216.

At 216, process 200 may involve mobile device 110 applying one or more parameters of the selected configuration file to respective one or more settings of the configuration of mobile device 110. Process 200 may proceed from 216 to 218.

At 218, process 200 may involve software applications on mobile device 110 applying changes according to the selected configuration file. For instance, one or more features provided by one or more applications may be enabled. Alternatively, or additionally, one or more other features provided by one or more applications may be disabled.

At 220, process 200 may involve mobile device 110 alerting or otherwise informing user 140 of the imminent configuration change. Process 200 may proceed from 220 to 222.

At 222, process 200 may involve mobile device 110 checking whether there is any user action in response to the alert. In an event that mobile device 110 detects a user action (e.g., a user input indicating user permission), process 200 may proceed from 222 to 224. Otherwise, in an event that no user action is detected or a user input indicating user disapproval, process 200 may proceed from 222 to 225.

At 224, process 200 may involve mobile device 110 showing progress of the configuration change on a display of mobile device 110. Process 200 may proceed from 224 to 226.

At 226, process 200 may involve mobile device 110 enabling one or more operator/carrier-specific applications and/or features specific to the operator/carrier associated with SIM card 120. Moreover, process 200 may involve mobile device 110 disabling one or more non-operator/carrier-specific applications and/or features not corresponding to the operator/carrier associated with SIM card 120. Process 200 may proceed from 226 to 228.

At 228, process 200 may involve mobile device 110 refreshing plug-in information as part of the configuration change.

At 225, process 200 may involve mobile device 110 performing any of the following: (1) providing no display of progress of the configuration change, (2) stopping the configuration change, and (3) taking one or more action(s) other than proceeding with the configuration change.

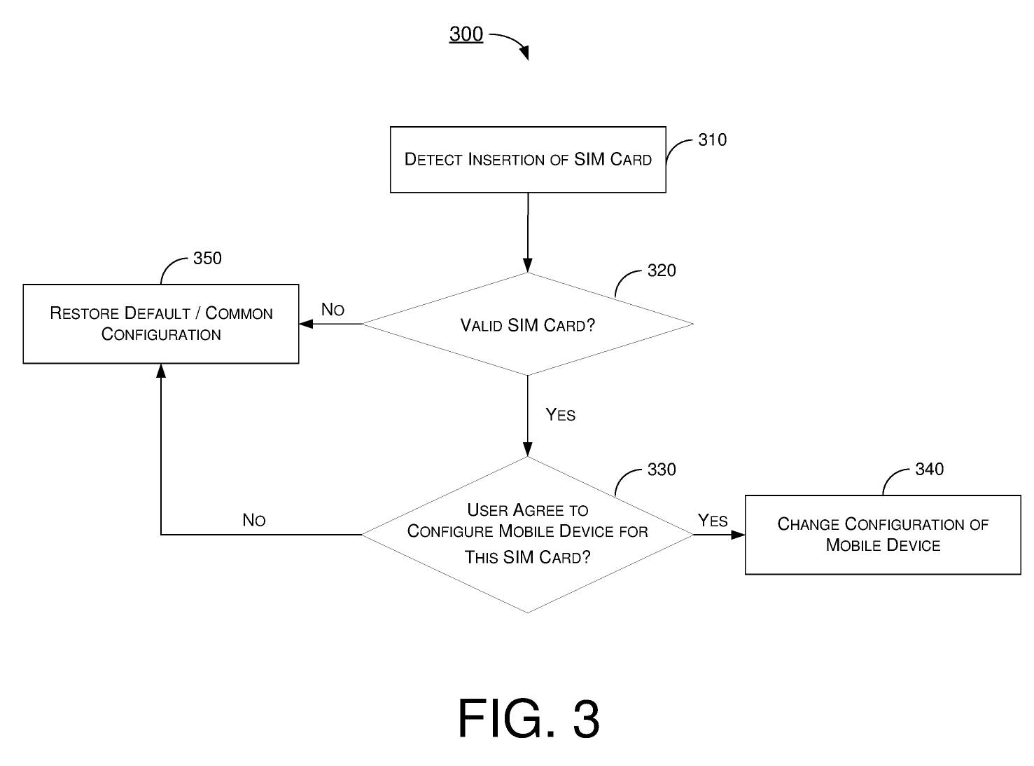

FIG. 3 illustrates an example process 300 mobile device configuration in accordance with an implementation of the present disclosure. Process 300 may include one or more operations, actions, or functions as represented by one or more of blocks 310, 320, 330, 340 and 350. Although illustrated as discrete blocks, various blocks of process 300 may be divided into additional blocks, combined into fewer blocks, or eliminated, depending on the desired implementation. Process 300 may be implemented in scenario 100 by mobile device 110. For illustrative purposes and without limitation, process 300 is described below in the context of mobile device 110 in scenario 100. Process 300 may begin at 310.

At 310, process 300 may involve mobile device 110 detecting an insertion of a SIM card (e.g., SIM card 120). Process 300 may proceed from 310 to 320.

At 320, process 300 may involve mobile device 110 determining whether or not SIM card 120 is valid. For instance, when the SIM card-specific information of SIM card 120 indicates SIM card 120 does not correspond to any of the multiple configuration files in the single software build 150 (e.g., MCC-MNC of SIM card 120 indicating a country and/or a region not supported by any of the configuration files), mobile device 110 may determine that SIM card 120 is invalid. In an event that the SIM card is determined to be invalid, process 300 may proceed from 320 to 350. Otherwise, in an event that the SIM card is determined to be valid, process 300 may proceed from 320 to 330.

At 330, process 300 may involve mobile device 110 checking whether user 140 agrees to configure mobile device 110 for SIM card 120. For instance, mobile device 110 may display a prompt on a UI to request user permission to proceed with configuration change. In an event that a user input indicates that user 140 does not agree to configure mobile device 110 for SIM card 120, process 300 may proceed from 330 to 350. Otherwise, in an event that the user input indicates that user 140 agrees to configure mobile device 110 for SIM card 120, process 300 may proceed from 320 to 340.

At 340, process 300 may involve mobile device 110 changing one or more settings of its configuration. For instance, mobile device 110 may select one of the multiple configuration files in the single software build 150 based on the SIM card-specific information obtained from SIM card 120, and then apply one or more parameters of the selected configuration file to respective one or more settings of the configuration of mobile device 110. As a result, for example, the appearance of an UI displayed by mobile device 110 may be changed. As another example, one or more features of mobile device 110 may be enabled, and one or more other features of mobile device 110 may be disabled.

At 350, process 300 may involve mobile device 110 restoring or otherwise implementing a default or common configuration (e.g., a configuration with factory settings) for mobile device 110. That is, in case that SIM card 120 is invalid or in case user 140 does not agree to configure mobile device 110 for SIM card 120, the default or common configuration may be utilized for mobile device 110.

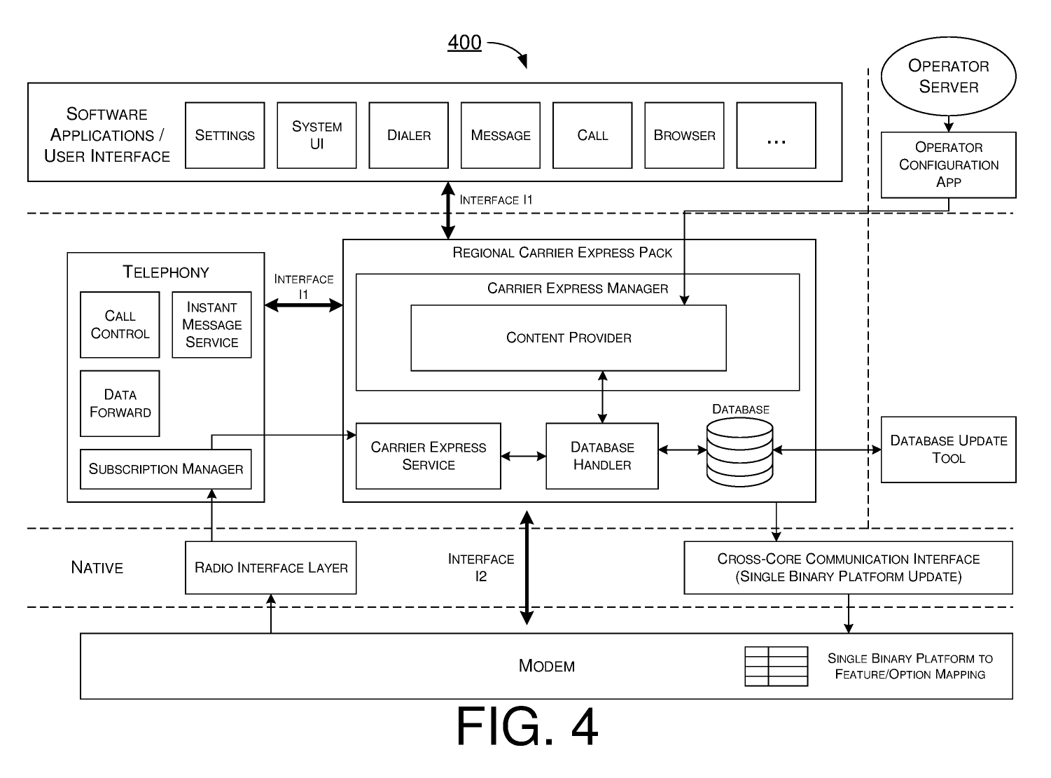

FIG. 4 illustrates an example software architecture 400 in accordance with an implementation of the present disclosure. Software architecture 400 may be implemented in mobile device 110 for various implementations of mobile device configuration in accordance with the present disclosure.

Referring to FIG. 4, software architecture 400 may include a regional carrier express pack (RCEP) that includes a configuration database. The configuration database may contain a plurality of configuration files which may be on a module basis. That is, each configuration file in the configuration database may be for a corresponding functional module (e.g., instant message service (IMS), call, dialer, system UI, browser, message, Wi-Fi and settings). In some implementations, there may be one table for each functional module. The configuration database may be static and may be dynamically updated. For instance, the configuration database may be updated via a database update tool (e.g., while mobile device 110 is in a vendor factory before release to the market) and/or updated by an operator configuration application on an operator server (e.g., over the air during runtime of mobile device 110). The RCEP may include a database handler that manages the configuration database. The RCEP may also include a carrier express manager having a content provider. The content provider may allow various applications to obtain configurable parameters (e.g., content value pairs) related to particular functional module(s).

The RCEP may communicate with higher-layer software applications and UIs via an interface 11. For instance, the RCEP may notify the functional modules of configuration change. Accordingly, the functional modules may obtain respective content values from the configuration database via the content provider. The RCEP may also communicate with telephony of mobile device 110 via the interface 11.

The RCEP may communicate with a modem of mobile device 110 via an interface 12. For instance, the RCEP may provide configuration parameters via the interface 12. Under the proposed scheme, each operator/carrier may correspond to a respective single binary platform (SBP) value. Based on the SIM card-specific information obtained from SIM card 120 (e.g., to which operator does SIM card 120 correspond), the RCEP may provide the SBP value for the specific operator to modem via a cross-core communication interface (CCCI). The modem may have a lookup table that stores correlations between operators and features/options. Thus, upon receiving the SBP value from the RCEP, the modem may implement specific features and/or options corresponding to the operator associated with the SBP value.

The operator server may transmit a notification to mobile device 110 to indicate availability of an update (e.g., software update) with respect to the configuration of mobile device 110. The configuration update may be downloaded from the operator configuration application and saved in the configuration database (e.g., in XML or another format). The database update tool may be used to modify the configuration database (e.g., for on-the-fly change).

### Illustrative Implementations

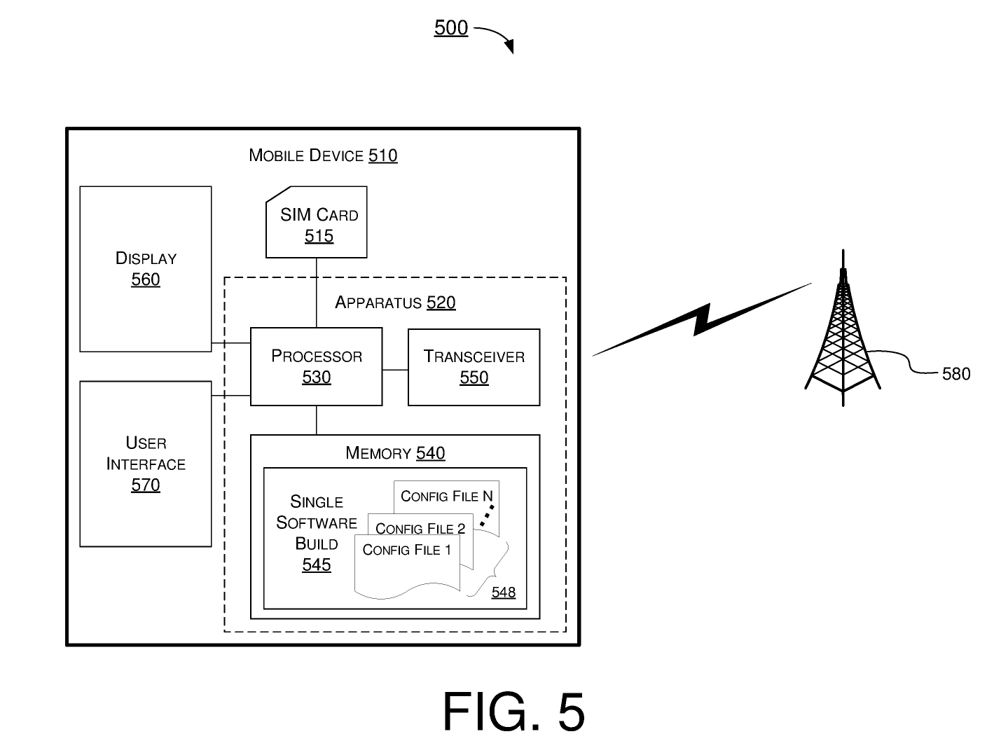

FIG. 5 illustrates an example system 500 having at least an example mobile device 510 and an operator network 580 of a service provider in accordance with an implementation of the present disclosure. Mobile device 510 may include an apparatus 520. Apparatus 520 may perform various functions to implement schemes, techniques, processes and methods described herein pertaining to mobile device configuration (e.g., for mobile device 510), including the various schemes described above with respect to various proposed designs, concepts, schemes, systems and methods described above with respect to FIG. 1˜FIG. 4 as well as process 600 described below.

Mobile device 510 may be a user equipment (UE), such as a portable or mobile apparatus, a wearable apparatus, a wireless communication apparatus or a computing apparatus. For instance, mobile device 510 may be implemented in a smartphone, a smartwatch, a personal digital assistant, a digital camera, or a computing equipment such as a tablet computer, a laptop computer or a notebook computer. Mobile device 510 may also be a part of a machine type apparatus, which may be an internet-of-things (IoT) apparatus such as an immobile or a stationary apparatus, a home apparatus, a wire communication apparatus or a computing apparatus. For instance, mobile device 510 may be implemented in a smart thermostat, a smart fridge, a smart door lock, a wireless speaker or a home control center. Operator network 580 may be implemented in an eNodeB in a Long-Term Evolution (LTE), LTE-Advanced or LTE-Advanced Pro network or in a gNB or transmission and reception point (TRP) in a 5G network, a New Radio (NR) network or an IoT network.

In some implementations, apparatus 520 may be implemented in the form of one or more integrated-circuit (IC) chips such as, for example and without limitation, one or more single-core processors, one or more multi-core processors, or one or more complex-instruction-set-computing (CISC) processors. Apparatus 520 may include at least some of those components shown in FIG. 5 such as a processor 530, for example. Apparatus 520 may further include one or more other components not pertinent to the proposed scheme of the present disclosure (e.g., power management circuitry), and, thus, such component(s) of apparatus 520 are neither shown in FIG. 5 nor described below in the interest of simplicity and brevity.

In one aspect, processor 530 may be implemented in the form of one or more single-core processors, one or more multi-core processors, or one or more CISC processors. That is, even though a singular term “a processor” is used herein to refer to processor 530, processor 530 may include multiple processors in some implementations and a single processor in other implementations in accordance with the present disclosure. In another aspect, processor 530 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 530 is a special-purpose machine specifically designed, arranged and configured to perform specific tasks including those pertaining to mobile device configuration in accordance with various implementations of the present disclosure.

In some implementations, apparatus 520 may also include a transceiver 550 coupled to processor 530. Transceiver 550 may be capable of wirelessly transmitting and receiving data. In some implementations, apparatus 520 may further include a memory 540 coupled to processor 530 and capable of being accessed by processor 530 and storing data therein. For instance, memory 540 may store a single software build 545 therein. The single software build 545 may be an example implementation of the single software build 150 of FIG. 1 and may at least contain a plurality of configuration files 548 (shown as Config File 1, Config File 2 . . . Config File N in FIG. 5, with N being a positive integer greater than 1). Memory 540 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 540 may include a type of read-only memory (ROM) such as mask ROM, programmable ROM (PROM), erasable programmable ROM (EPROM) and/or electrically erasable programmable ROM (EEPROM). Alternatively, or additionally, memory 540 may include a type of non-volatile random-access memory (NVRAM) such as flash memory, solid-state memory, ferroelectric RAM (FeRAM), magnetoresistive RAM (MRAM) and/or phase-change memory.

In some implementations, mobile device 510 may also include a display device 560 and a user interface (UI) 570. Each of display device 560 and UI 570 may be communicatively coupled to processor 530 to provide data to processor 530 and receive data and commands from processor 530. Display device 560 may be capable of presenting textual, audio and/or video information to a user (e.g., user 140) of mobile device 510 including, for example, setting menu 160 as shown in FIG. 1. UI 570 may be capable of receiving user inputs, as user commands, to trigger processor 530 to execute or otherwise perform various tasks, actions and/or operations. In some implementations, display device 560 and UI 570 may be integrated in a single unit such as a touch-sensing panel that is capable of displaying data/information as well as receiving user inputs. In some implementations, mobile device 510 may receive a SIM card 515 therein (e.g., with SIM card 515 inserted into a SIM card slot in mobile device 510). Once inserted or otherwise received in mobile device 510, SIM card 515 may be communicatively coupled to processor 530 such that processor 530 may retrieve or otherwise obtain data/information from SIM card 515.

Under the proposed scheme in accordance with the present disclosure, processor 530 may detect an occurrence of an event and, in response to detecting the occurrence of the event, processor 530 may apply one or more aspects of one of the plurality of configuration files 548 to one or more settings of a configuration of the mobile device. In some implementations, the event may include one of the following: (1) detecting an insertion of a SIM card (e.g., SIM card 515) into mobile device 510, (2) receiving during runtime, via transceiver 550, a notification from a service provider (e.g., from operator network 580) indicating availability of an upgrade for the one of the plurality of configuration files 548, and (3) receiving, via UI 570, a user command to change one or more settings of the configuration of mobile device 510.

In some implementations, in response to detecting the insertion of SIM card 515 into mobile device 510, processor 530 may obtain SIM card-specific information from SIM card 515. In some implementations, the SIM card-specific information obtained by processor 530 may include some or all of the following: a mobile country code (MCC), a mobile network code (MNC), a service provider name (SPN), a level 1 group identifier (GID1), and an integrated-circuit card identifier (ICCID) of SIM card 515.

In some implementations, in applying the one or more aspects of one of the plurality of configuration files 548 stored in memory 540, processor 530 may select a first configuration file of the plurality of configuration files 548 based on the SIM card-specific information. Moreover, processor 530 may apply one or more parameters of the first configuration file to one or more settings of the configuration of mobile device 510.

In some implementations, in response to detecting the insertion of SIM card 515 into mobile device 510, processor 530 may also determine whether SIM card 515 is valid based on the SIM card-specific information. Additionally, processor 530 may perform either of the following: (a) applying one or more parameters of a first configuration file of the plurality of configuration files 548 to one or more settings of the configuration of mobile device 510 responsive to the determining indicating that SIM card 515 is valid, and (b) applying one or more parameters of a second configuration file of the plurality of configuration files 548 to the one or more settings of the configuration of mobile device 510 responsive to the determining indicating that SIM card 515 is invalid.

In some implementations, in an event that processor 530 receives the notification from the service provider indicating the availability of the upgrade for the one of the plurality of configuration files 548, in applying the one or more aspects of the one of the plurality of configuration files 548 stored in memory 540, processor 530 may perform a number of operations. For instance, processor 530 may download, via transceiver 550, the upgrade from a server of the service provider via operator network 580. Additionally, processor 530 may update the one of the plurality of configuration files 548 with the upgrade. Moreover, processor 530 may apply one or more parameters of the one of the plurality of configuration files 548 to one or more settings of the configuration of mobile device 510.

In some implementations, in applying the one or more aspects of the one of the plurality of configuration files 548 stored in memory 540, processor 530 may perform either of the following: (a) installing one or more software applications on mobile device 510 according to the one of the plurality of configuration files 548, and (b) updating a UI on mobile device 510 or one or more software applications installed on mobile device 510 according to the one of the plurality of configuration files 548.

In some implementations, in applying the one or more aspects of the one of the plurality of configuration files 548 stored in memory 540, processor 530 may enable a first feature of mobile device 510 (e.g., a first software application installed on mobile device 510). Alternatively, or additionally, processor 530 may disable a second feature of mobile device 510 (e.g., a second software application installed on mobile device 510).

In some implementations, in applying the one or more aspects of the one of the plurality of configuration files 548 stored in memory 540, processor 530 may request, via UI 570, for user permission from a user. Moreover, processor 530 may apply the one or more aspects of the one of the plurality of configuration files 548 to one or more settings of the configuration of mobile device 510 responsive to receiving a positive user response as the user permission.

### Illustrative Processes

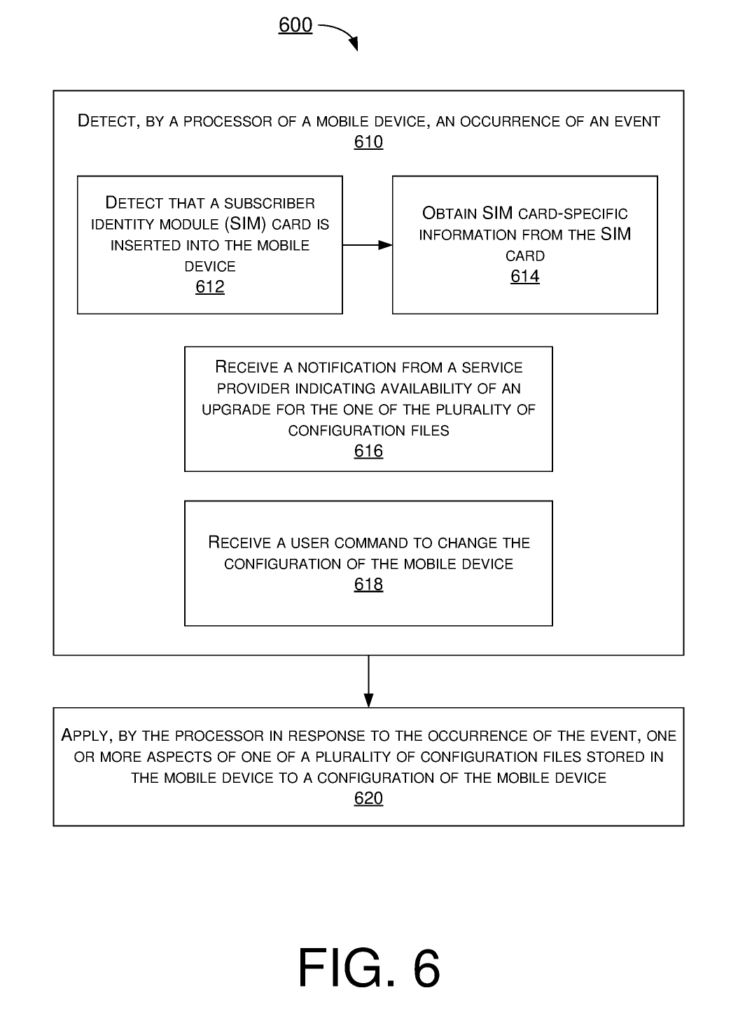

FIG. 6 illustrates an example process 600 in accordance with an implementation of the present disclosure. Process 600 may represent an aspect of implementing the proposed concepts and schemes pertaining to mobile device configuration. Process 600 may be an example implementation, whether partially or entirely, of the concepts and schemes described above with respect to FIG. 1˜FIG. 5. Process 600 may include one or more operations, actions, or functions as illustrated by one or more of blocks 610 and 620 as well as sub-blocks 612, 614, 616 and 618. Although illustrated as discrete blocks/sub-blocks, various blocks/sub-blocks of process 600 may be divided into additional blocks/sub-blocks, combined into fewer blocks, or eliminated, depending on the desired implementation. Moreover, the blocks/sub-blocks of process 600 may be executed in the order shown in FIG. 6 or, alternatively in a different order. One or more of the blocks/sub-blocks of process 600 may be executed iteratively. Process 600 may be implemented by apparatus 520 in mobile device 510 as well as any variations thereof. Solely for illustrative purposes and without limiting the scope, process 600 is described below in the context of apparatus 520 in mobile device 510 as a UE. Process 600 may begin at block 610.

At 610, process 600 may involve processor 530 of apparatus 520 detecting an occurrence of an event. Process 600 may proceed from 610 to 620.

At 620, process 600 may involve processor 530, in response to the occurrence of the event, applying one or more aspects of one of a plurality of configuration files 548 stored in mobile device 510 to one or more settings of a configuration of mobile device 510.

In some implementations, in detecting the occurrence of the event, process 600 may involve processor 530 detecting that a SIM card (e.g., SIM card 515) is inserted into mobile device 510. Additionally, process 600 may involve processor 530 obtaining SIM card-specific information from SIM card 515.

In some implementations, the SIM card-specific information obtained by processor 530 may include some or all of a MCC, a MNC, a SPN, a GID1, and an ICCID of SIM card 515.

In some implementations, in applying the one or more aspects of one of the plurality of configuration files stored in mobile device 510, process 600 may involve processor 530 selecting a first configuration file of the plurality of configuration files 548 based on the SIM card-specific information. Moreover, process 600 may involve processor 530 applying one or more parameters of the first configuration file to one or more settings of the configuration of mobile device 510.

In some implementations, in detecting the occurrence of the event, process 600 may also involve processor 530 determining whether SIM card 515 is valid based on the SIM card-specific information. Furthermore, process 600 may involve processor 530 performing either of the following: (a) applying one or more parameters of a first configuration file of the plurality of configuration files 548 to one or more settings of the configuration of mobile device 510 responsive to the determining indicating that SIM card 515 is valid, and (b) applying one or more parameters of a second configuration file of the plurality of configuration files 548 to the one or more settings of the configuration of mobile device 510 responsive to the determining indicating that SIM card 515 is invalid.

In some implementations, in detecting the occurrence of the event, process 600 may involve processor 530 receiving, via transceiver 550 and operator network 580, a notification from a service provider indicating availability of an upgrade for the one of the plurality of configuration files 548.

In some implementations, in applying the one or more aspects of the one of the plurality of configuration files 548 stored in mobile device 510, process 600 may involve processor 530 downloading, via transceiver 550, the upgrade from a server of the service provider via operator network 580. Additionally, process 600 may involve processor 530 updating the one of the plurality of configuration files 548 with the upgrade. Moreover, process 600 may involve processor 530 applying one or more parameters of the one of the plurality of configuration files 548 to one or more settings of the configuration of mobile device 510.

In some implementations, in detecting the occurrence of the event, process 600 may involve processor 530 receiving, via UI 570, a user command to change one or more settings of the configuration of mobile device 510.

In some implementations, in applying the one or more aspects of the one of the plurality of configuration files 548 stored in mobile device 510, process 600 may involve processor 530 performing either of the following: (a) installing one or more software applications on mobile device 510 according to the one of the plurality of configuration files 548, and (b) updating a UI on mobile device 510 or one or more software applications installed on mobile device 510 according to the one of the plurality of configuration files 548.

In some implementations, in applying the one or more aspects of the one of the plurality of configuration files 548 stored in mobile device 510, process 600 may involve processor 530 enabling a first feature of mobile device 510. Alternatively, or additionally, process 600 may involve processor 530 disabling a second feature of mobile device 510. In some implementations, the first feature may include a first software application installed on mobile device 510. In some implementations, the second feature may include a second software application installed on mobile device 510.

In some implementations, in applying the one or more aspects of the one of the plurality of configuration files 548 stored in mobile device 510, process 600 may involve processor 530 requesting, via UI 570, for user permission from a user of mobile device 510. Additionally, process 600 may involve processor 530 applying the one or more aspects of the one of the plurality of configuration files 548 to one or more settings of the configuration of mobile device 510 responsive to receiving a positive user response as the user permission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of a mobile device, an occurrence of an event; and
applying, by the processor in response to the occurrence of the event, one or more aspects of one of a plurality of configuration files stored in the mobile device to a configuration of the mobile device.

2. The method of claim 1, wherein the detecting of the occurrence of the event comprises:
detecting that a subscriber identity module (SIM) card is inserted into the mobile device; and
obtaining SIM card-specific information from the SIM card.

3. The method of claim 2, wherein the SIM card-specific information comprises some or all of a mobile country code (MCC), a mobile network code (MNC), a service provider name (SPN), a level 1 group identifier (GID1), and an integrated-circuit card identifier (ICCID) of the SIM card.

4. The method of claim 2, wherein the applying of the one or more aspects of one of the plurality of configuration files stored in the mobile device comprises:
selecting a first configuration file of the plurality of configuration files based on the SIM card-specific information; and
applying one or more parameters of the first configuration file to one or more settings of the configuration of the mobile device.

5. The method of claim 2, wherein the detecting of the occurrence of the event further comprises:
determining whether the SIM card is valid based on the SIM card-specific information; and
performing either of:
applying one or more parameters of a first configuration file of the plurality of configuration files to one or more settings of the configuration of the mobile device responsive to the determining indicating that the SIM card is valid; and
applying one or more parameters of a second configuration file of the plurality of configuration files to the one or more settings of the configuration of the mobile device responsive to the determining indicating that the SIM card is invalid.

6. The method of claim 1, wherein the detecting of the occurrence of the event comprises receiving a notification from a service provider indicating availability of an upgrade for the one of the plurality of configuration files.

7. The method of claim 6, wherein the applying of the one or more aspects of the one of the plurality of configuration files stored in the mobile device comprises:
downloading the upgrade from a server of the service provider;
updating the one of the plurality of configuration files with the upgrade; and
applying one or more parameters of the one of the plurality of configuration files to one or more settings of the configuration of the mobile device.

8. The method of claim 1, wherein the detecting of the occurrence of the event comprises receiving a user command to change one or more settings of the configuration of the mobile device.

9. The method of claim 1, wherein the applying of the one or more aspects of the one of the plurality of configuration files stored in the mobile device comprises performing either of:
installing one or more software applications on the mobile device according to the one of the plurality of configuration files; and
updating a user interface (UI) on the mobile device or one or more software applications installed on the mobile device according to the one of the plurality of configuration files.

10. The method of claim 1, wherein the applying of the one or more aspects of the one of the plurality of configuration files stored in the mobile device comprises:
enabling a first feature of the mobile device; and
disabling a second feature of the mobile device.

11. The method of claim 10, wherein the first feature comprises a first software application installed on the mobile device, and wherein the second feature comprises a second software application installed on the mobile device.

12. The method of claim 1, wherein the applying of the one or more aspects of the one of the plurality of configuration files stored in the mobile device comprises:
requesting, via a user interface (UI), for user permission from a user; and
applying the one or more aspects of the one of the plurality of configuration files to one or more settings of the configuration of the mobile device responsive to receiving a positive user response as the user permission.

13. An apparatus implementable in a mobile device, comprising:
a memory capable of storing a plurality of configuration files; and
a processor capable of accessing the plurality of configuration files stored in the memory, the processor further capable of performing operations comprising:
detecting an occurrence of an event; and
applying, in response to the occurrence of the event, one or more aspects of one of the plurality of configuration files to a configuration of the mobile device,
wherein the event comprises one of:
detecting an insertion of a subscriber identity module (SIM) card into the mobile device;
receiving a notification from a service provider indicating availability of an upgrade for the one of the plurality of configuration files; and
receiving a user command to change the configuration of the mobile device.

14. The apparatus of claim 13, wherein, in response to the detecting of the insertion of the SIM card into the mobile device, the processor obtains SIM card-specific information from the SIM card, and wherein the SIM card-specific information comprises some or all of a mobile country code (MCC), a mobile network code (MNC), a service provider name (SPN), a level 1 group identifier (GID1), and an integrated-circuit card identifier (ICCID) of the SIM card.

15. The apparatus of claim 13, wherein, in applying the one or more aspects of one of the plurality of configuration files stored in the memory, the processor performs operations comprising:
selecting a first configuration file of the plurality of configuration files based on the SIM card-specific information; and
applying one or more parameters of the first configuration file to one or more settings of the configuration of the mobile device.

16. The apparatus of claim 13, wherein, in response to the detecting of the insertion of the SIM card into the mobile device, the processor further performs operations comprising:
determining whether the SIM card is valid based on the SIM card-specific information; and
performing either of:
applying one or more parameters of a first configuration file of the plurality of configuration files to one or more settings of the configuration of the mobile device responsive to the determining indicating that the SIM card is valid; and
applying one or more parameters of a second configuration file of the plurality of configuration files to the one or more settings of the configuration of the mobile device responsive to the determining indicating that the SIM card is invalid.

17. The apparatus of claim 13, wherein the detecting of the occurrence of the event comprises receiving the notification from the service provider indicating the availability of the upgrade for the one of the plurality of configuration files, and wherein, in applying the one or more aspects of the one of the plurality of configuration files stored in the memory, the processor performs operations comprising:
downloading the upgrade from a server of the service provider;
updating the one of the plurality of configuration files with the upgrade; and
applying one or more parameters of the one of the plurality of configuration files to one or more settings of the configuration of the mobile device.

18. The apparatus of claim 13, wherein, in applying the one or more aspects of the one of the plurality of configuration files stored in the memory, the processor performs either of:
installing one or more software applications on the mobile device according to the one of the plurality of configuration files; and
updating a user interface (UI) on the mobile device or one or more software applications installed on the mobile device according to the one of the plurality of configuration files.

19. The apparatus of claim 13, wherein, in applying the one or more aspects of the one of the plurality of configuration files stored in the memory, the processor performs operations comprising:
enabling a first software application installed on the mobile device; and
disabling a second software application installed on the mobile device.

20. The apparatus of claim 13, wherein, in applying the one or more aspects of the one of the plurality of configuration files stored in the memory, the processor performs operations comprising:
requesting, via a user interface (UI), for user permission from a user; and
applying the one or more aspects of the one of the plurality of configuration files to one or more settings of the configuration of the mobile device responsive to receiving a positive user response as the user permission.
